(19) United States
(12) Patent Application Publication
(10) Pub. No.: US 2026/0246396 A1
(43) Pub. Date: Aug. 20, 2026

(54) Electromagnetic-Triboelectric Hybrid Energy Harvesting Unit, Tile and Floor System

(71) Applicant: City University of Hong Kong, Hong Kong (HK)

(72) Inventors: Steven WANG, Hong Kong (HK); Long GU, Hong Kong (HK); Wai Kin LO, Hong Kong (HK)

(21) Appl. No.: 19/056,645

(22) Filed: Feb. 18, 2025

(51) Int. Cl. H02N 1/04; E04F 15/22; H02J 7/00; H02K 35/04

(52) U.S. Cl. CPC H02N 1/04; E04F 15/22; H02J 7/855; H02K 35/04

(57) ABSTRACT

The present invention provides a hybrid energy harvesting (HEH) floor system comprising a plurality of HEH tiles. The HEH tile comprises: a top board; a bottom board; and an array of HEH units arranged between the top and bottom boards, and configured for harvesting kinetic energy from pedestrian stepping and generating electrical energy from the kinetic energy. Each HEH unit includes a triboelectric harvesting unit for harvesting kinetic energy from small-scale motions and an electromagnetic harvesting unit for harvesting kinetic energy from large-scale motions. Each HEH unit is operable at a compressed state when the HEH floor system is compressed by an external force and at a released state when there is no external force compressing the HEH floor system. The provided HEH floor system is particularly suitable to be installed on the densely populated area to efficiently capture and convert the kinetic energy produced by pedestrians' walking.

### FIELD OF THE INVENTION

The present invention generally relates to hybrid energy harvesting floor system. More specifically the present invention relates to hybrid energy harvesting floor system based on electromagnetic and triboelectric generators.

### BACKGROUND OF THE INVENTION

To reduce the dependence on commercial electricity and support a green society, it is beneficial to develop an alternative to fulfil the power requirements. In order to enhance energy resilience and reduce greenhouse gas emissions, and cope with the rapid development of smart cities, new forms of sustainable renewable energy generation that complements existing sources such as solar and wind power are getting more and more interests.

One solution is implementing energy harvesting floor systems to capture and convert the mechanical energy generated by human motion, such as walking, into usable electrical energy. Electromagnetic generators, which typically rely on relative motion between magnets and coils, are a popular choice for converting mechanical energy into electrical energy. However, these generators have limited efficiencies at micro-and nano-scales due to challenges in scaling down the magnetic components and maintaining a strong electromagnetic coupling.

Triboelectric nanogenerator (TENG) can convert mechanical energy into electrical energy through the triboelectric effect and electrostatic induction. The triboelectric effect, commonly observed in everyday static electricity, occurs when two materials come into contact and then separate, resulting in a transfer of electric charge. TENGs leverage this phenomenon to create sustainable and versatile energy solutions, particularly in applications requiring low-power outputs.

### SUMMARY OF THE INVENTION

It is an objective of the present invention to provide a hybrid renewable and decentralized energy harvesting floor system that can effectively harvest multi-scale, irregular and wide frequency-distributed mechanical energy and convert the same into usable electrical energy.

In accordance with a first aspect of the present invention, a hybrid energy harvesting unit is provided for harvesting kinetic energy from pedestrian stepping and generating electrical energy from the kinetic energy. The hybrid energy harvesting unit comprises: a triboelectric harvesting unit for harvesting kinetic energy from small-scale motions; and an electromagnetic harvesting unit for harvesting kinetic energy from large-scale motions. The hybrid energy harvesting unit is operable at a compressed state when the hybrid energy harvesting unit is compressed by an external force and a released state when there is no external force compressing the hybrid energy harvesting unit.

In accordance with a second aspect of the present invention, a hybrid energy harvesting tile is provided for harvesting kinetic energy from pedestrian stepping and generating electrical energy from the kinetic energy. The hybrid energy harvesting tile comprises a top board; a bottom board; a second set of springs arranged between and resiliently connecting the top board and the bottom board; and an array of hybrid energy harvesting units of the first aspect of the present invention arranged between and resiliently connecting the top board and the bottom board.

In accordance with a third aspect of the present invention, a hybrid energy harvesting floor system is provided for harvesting kinetic energy from pedestrian stepping and generating electrical energy from the kinetic energy. The hybrid energy harvesting floor system comprises one or more hybrid energy harvesting tiles of the second aspect of the present invention.

The synergistic energy harvesting floor system is particularly suitable to be installed underneath the tiles in the densely populated area to efficiently capture and convert the kinetic energy produced by pedestrians' walking. As EMG is efficient for high-frequency and high-output energy harvesting, while TENG works well for low-frequency and small-scale energy capture, the energy harvesting floor system can leverage the complementary strengths of both generators. Evaluation experiments show that the system can reach a voltage and current peak output of 30 V and 3 mA, respectively. The invention can also be fully integrated with power management component and energy storage component, and then feed into the city's infrastructure to support its normal functions.

### BRIEF DESCRIPTION OF THE DRAWINGS

Embodiments of the invention are described in more details hereinafter with reference to the drawings, in which:

FIG. 1 illustrates a 3D drawing of a hybrid energy harvesting tile in accordance with one embodiment of the present invention;

FIG. 2 illustrates a hybrid energy harvesting unit in accordance with one embodiment of the present invention;

FIGS. 3A and 3B illustrate an isometric exploded view and a side exploded view of a hybrid energy harvesting unit in accordance with one embodiment of the present invention respectively;

FIGS. 4A and 4B show the hybrid energy harvesting unit operated at the released state and compressed state respectively;

FIG. 5 shows working mechanism of the triboelectric harvesting unit;

FIG. 6 shows working mechanism of the electromagnetic harvesting unit;

FIG. 7 shows a diagram of a power management circuitry;

FIGS. 8A and 8B show two different views of a prototype of a hybrid energy harvesting unit in accordance with the present invention respectively;

FIGS. 9A to 9C show top view, side view and interior structure of a prototype of a hybrid energy harvesting title in accordance with the present invention respectively;

FIGS. 10A and 10B show output voltage and output current of the hybrid energy harvesting tile respectively;

FIG. 11 shows a charging curve for charging a 470 μF capacitor using the hybrid energy harvesting tile.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

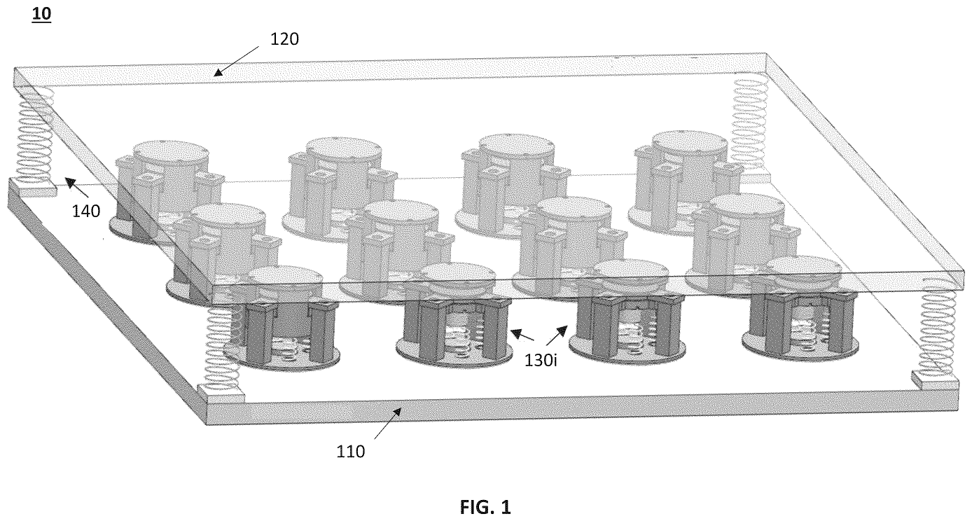

FIG. 1 illustrates a 3D drawing of a hybrid energy harvesting tile 10 in accordance with one embodiment of the present invention. The hybrid energy harvesting tile comprises a top board 110; a bottom board 120; and an array of hybrid energy harvesting units 130i arranged between the top and bottom boards 110 and 120, and configured for harvesting kinetic energy from pedestrian stepping and generating electrical energy from the kinetic energy. The top and bottom boards may be made of metal, ceramic, polymer materials or any other suitable types of materials, and manufactured to have various shapes, including but not limited to, square, rectangle, triangle.

Each hybrid energy harvesting unit 130i includes a triboelectric harvesting unit 131 for harvesting kinetic energy from small-scale motions and an electromagnetic harvesting unit 132 for harvesting kinetic energy from large-scale motions.

When the hybrid energy harvesting tile 10 is compressed by an external force, such as stepping by a pedestrian, each hybrid energy harvesting units is at a compressed state. When there is no external force compressing the hybrid energy harvesting tile, each hybrid energy harvesting unit is at a released state.

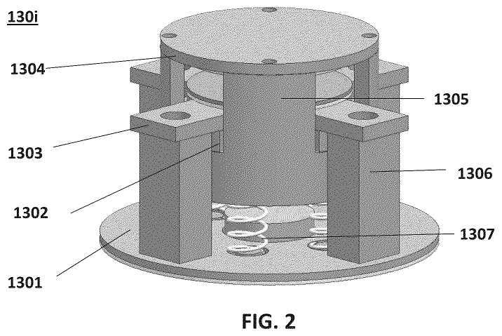

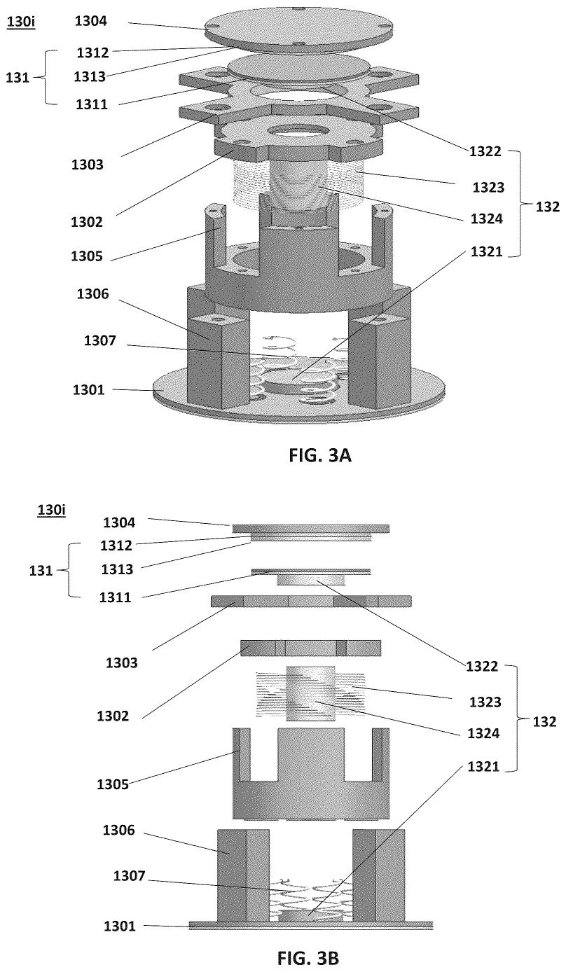

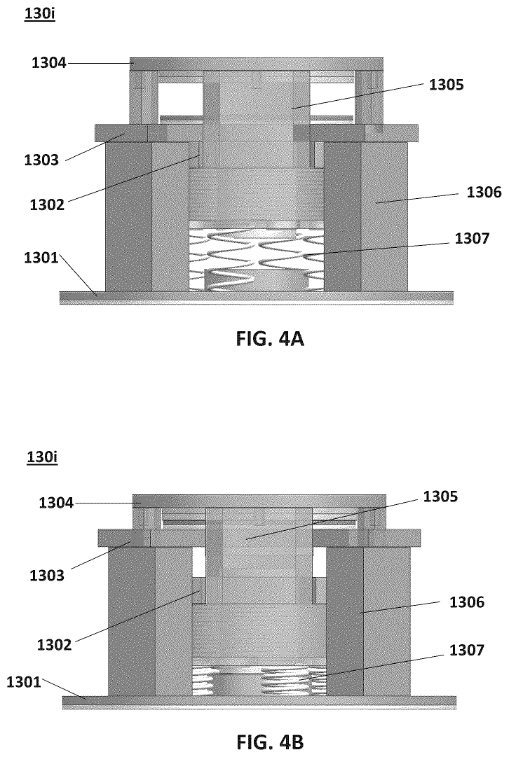

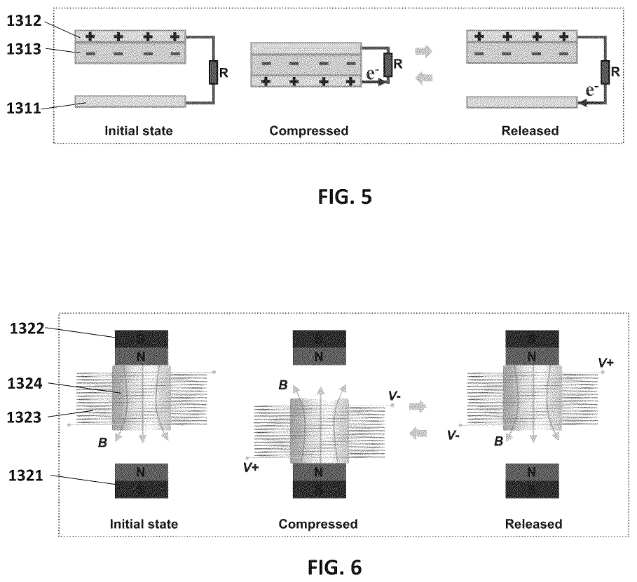

FIG. 2 illustrates an isometric view of a hybrid energy harvesting unit in accordance with one embodiment of the present invention. FIGS. 3A and 3B illustrate an isometric exploded view and a side exploded view of a hybrid energy harvesting unit in accordance with one embodiment of the present invention respectively. FIGS. 4A and 4B show the hybrid energy harvesting unit operated at the released state and compressed state respectively. FIG. 5 shows working mechanism of the triboelectric harvesting unit. FIG. 6 shows working mechanism of the electromagnetic harvesting unit.

The hybrid energy harvesting unit 130i includes: a bottom plate 1301; a lower mounting frame 1302 arranged above the bottom plate 1301; an upper mounting frame 1303 arranged above the lower mounting frame 1302; and a top plate 1304 arranged above the upper mounting frame 1303.

The hybrid energy harvesting unit 130i further includes a spacing structure 1305 rigidly linking and spacing apart the lower mounting frame 1302 and the top plate 1304, and one or more spacing structures 1306 rigidly linking and spacing apart the upper mounting frame 1303 and the bottom plate 1301. The spacing structure 1305 is arranged to pass through the upper mounting frame 1303 such that the top plate 1304, the lower mounting frame 1302 and the spacing structure 1305 forms a rigid body movable between a high position when the hybrid energy harvesting unit is at the released state (FIG. 4A) and a low position when the hybrid energy harvesting unit is at the compressed state (FIG. 4B).

The triboelectric harvesting unit 131 includes a first electrode 1311 disposed on a top surface of the upper mounting frame 1303; a second electrode 1312 disposed on a bottom surface of the top plate 1304; a first triboelectric layer 1313 made of a tribo-negative material and attached to a bottom surface of the second electrode 1312. The first electrode 1311 is made of a tribo-positive material and configured to also act a second triboelectric layer. The first triboelectric layer 1313 is configured to be movable to be apart from or in contact with the second triboelectric layer 1311. Alternatively, the first triboelectric layer 1313 may be made of tribo-positive materials and the second triboelectric layer 1311 may be made of tribo-negative materials.

In some embodiments, the triboelectric harvesting unit 131 may further include a second triboelectric layer (not shown) made of a tribo-positive material and attached to the first electrode 1311. The first triboelectric layer 1313 is configured to be movable to be apart from or in contact with the second triboelectric layer. Alternatively, the first triboelectric layer 1313 may be made of tribo-positive materials and the second triboelectric layer may be made of tribo-negative materials.

The tribo-negative material may be selected from, but not limited to, FEP, PTFE, PVDF. The tribo-positive material may be selected from, but not limited to, nylon, PU, Cu, Al.

The electromagnetic harvesting unit 132 includes a first magnet 1321 fixed on a top surface of the bottom plate 1301; a second magnet 1322 attached to a bottom surface of the first electrode 1311 and arranged to pass through a central opening of the upper mounting frame 1303 (in other words, the second magnet 1322 is fixed to the upper mounting frame 1303 through the first electrode 1311); and a high-density conductive coil 1323 fixed on the lower mounting frame 1302 and configured to be movable up and down between the first and second magnets. The first and second magnets are aligned oppositely, that is, assembled face-to-face with same poles. Preferably, the first and second magnets are circular magnets. In some embodiments, the magnets may have rectangular shape, triangular shape or any other suitable shapes.

In some embodiments, the electromagnetic harvesting unit 132 may further include a magnetic core 1324 fixed on the lower mounting frame 1302 and surrounded by the conductive coil 1323. The magnetic core is made of magnetic material with a high magnetic permeability and used to confine the magnetic field and reinforce the magnetic flux in the electromagnetic harvesting unit such that the moving speed of the moveable part can be speeded up and resulting an enhanced output.

As the magnetic core contacts magnetic poles of the two magnets successively, the magnetic flux passing through the coil changes, and thereby inducing an electromotive force. At the same time, the periodic contact and separation of the triboelectric materials in the hybrid generator generates Maxwell displacement current and potential difference through the triboelectrification and electrostatic induction effects.

The hybrid energy harvesting unit 130i further includes a set of springs 1307 resiliently connecting the lower mounting frame and the bottom plate. When the hybrid energy harvesting tile is impacted by a mass (e.g., stepped by a pedestrian) and caused to have an up-down movement, the springs 1307 may be arranged to store kinetic energy of the mass and maintain a vibrational motion to facilitate the electromagnetic harvesting unit and the triboelectric harvesting unit to harvest the kinetic energy.

The spring 1307 may further be configured to biasing or resetting the hybrid energy harvesting unit 130i to an initial state when there is no stepping on the hybrid energy harvesting tile.

In some embodiments, the hybrid energy harvesting tile 10 further comprises additional set of springs 140 arranged between and resiliently connecting the top board 120 and the bottom board 110; and configured for buffering for the impact on the floor system. This makes it easier for people to step on and provides a strong upward force on the floor, promoting rapid reset of the hybrid energy harvesting unit. Each of the bottom and top boards may have holes or guide rails for fixing and guiding the springs such that when the floor is stepped on by pedestrian traffic, the top board moves under the action of the guide rails to maintain vertical movement.

The hybrid energy harvesting tile further comprises a power management circuitry (not shown) installed on the lower board and configured for storing the generated electrical energy or transferring the generated electrical energy to an energy storage device, e.g. a battery or directly using the generated electrical energy for powering an application load.

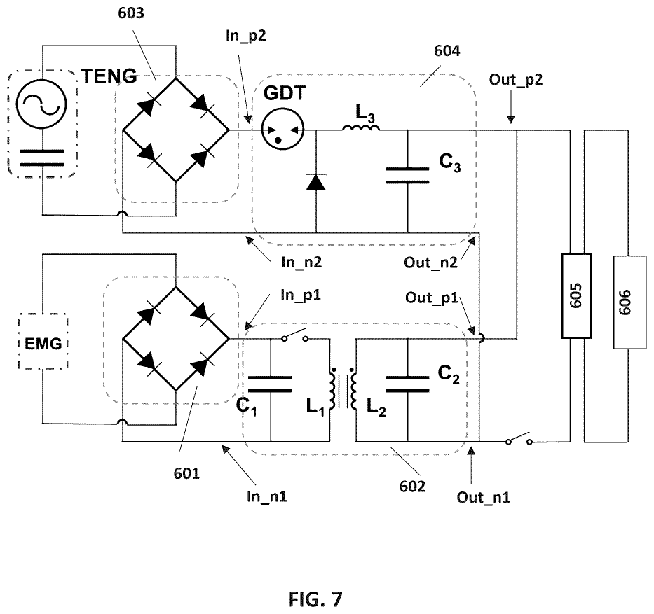

Referring to FIG. 7, the power management circuitry includes a first rectifier circuit electrically coupled to the triboelectric harvesting unit; a first voltage boosting and stabilization circuit electrically coupled to the first rectifier circuit; a second rectifier circuit electrically coupled to the electromagnetic harvesting unit; and a second voltage boosting and stabilization circuit electrically coupled to the second rectifier circuit.

The power management circuitry further includes a battery charging and discharging management circuit connected in parallel to the first and second voltage boosting and stabilization circuits; and a load or battery electrically connect to the battery charging and discharging management circuit.

The unstable AC power generated by the hybrid energy harvesting unit is connected to the rectifier circuits and then to the voltage boosting and stabilization circuits for voltage boosting and stabilization. It is then connected to the battery charging and discharging management circuit and finally connected to the rechargeable battery. Through the battery charging and discharging management circuit, efficient charging and discharging management of the battery can be achieved, maximizing the power generation efficiency and battery lifespan.

The first voltage boosting and stabilization circuit has a positive input node In_p1, a negative input node In_n1, a positive output node Out_p1 and a negative output node Out_n1.

The first voltage boosting and stabilization circuit includes a capacitor C1 having a first terminal electrically connected to the positive input node In_p1 and a second terminal electrically connected to the negative input node In_n1; a capacitor C2 having a first terminal electrically connected to the positive output node Out_p1 and a second terminal electrically connected to the negative output node Out_n1; and a transformer having a primary winding L1 connected in parallel to the capacitor C1 and a secondary winding L2 connected in parallel to the capacitor C2.

The second voltage boosting and stabilization circuit has a positive input node In_p2, a negative input node In_n2, a positive output node Out_p2 and a negative output node Out_n2.

The second voltage boosting and stabilization circuit includes a gas discharge tube (GDT) having a first terminal electrically connected to the positive input node In_p2; a diode D1 having a cathode electrically connected to a second terminal of the GDT and an anode electrically connected to the negative input node In_n2; a inductor L3 having a first terminal electrically connected to the second terminal of the GDT; and a capacitor C3 having a first terminal electrically connected to the positive output node Out_p2 and a second terminal electrically connected to the negative output node Out_n2.

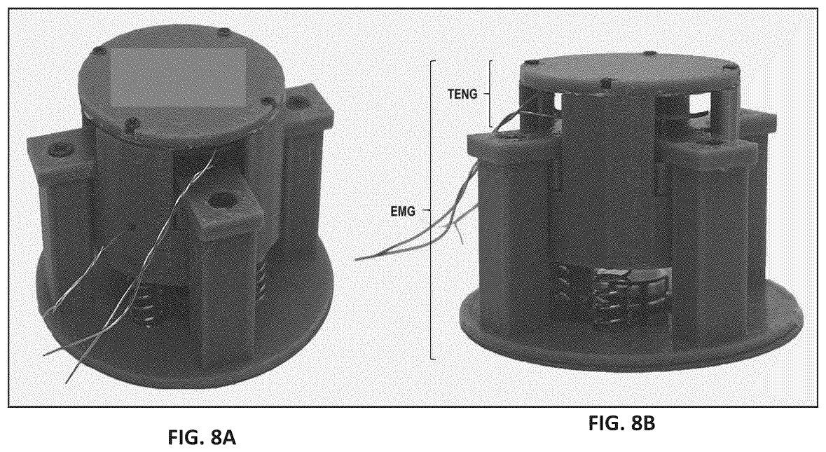

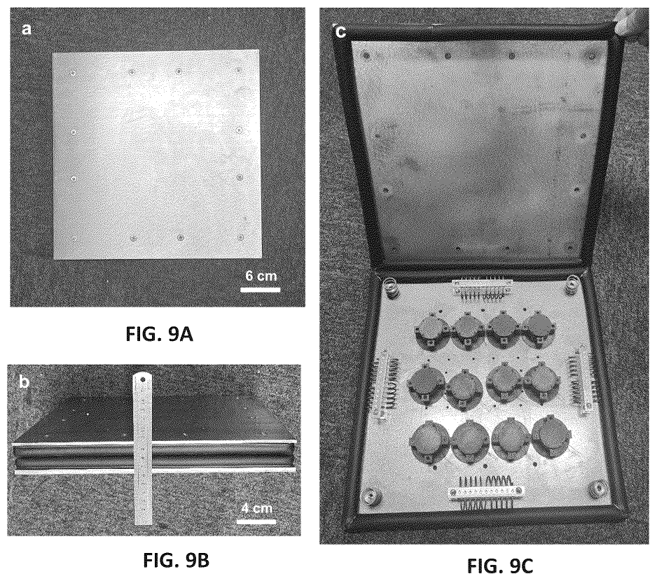

FIGS. 8A and 8B show a prototype of a hybrid energy harvesting unit in accordance with the present invention. FIGS. 9A to 9C show a prototype of a hybrid energy harvesting title in accordance with the present invention.

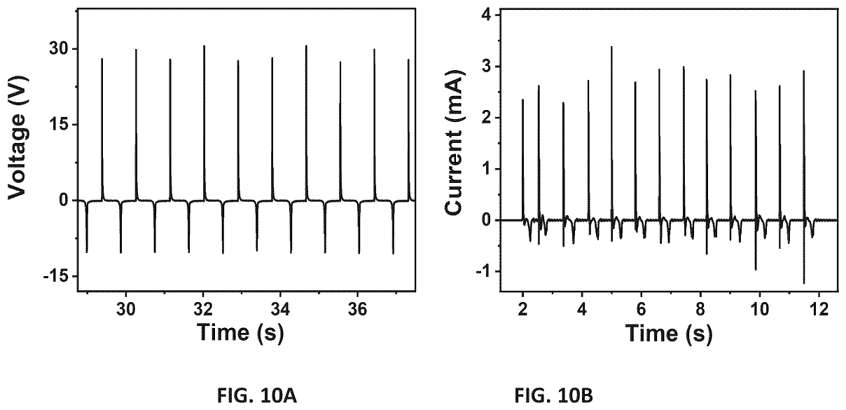

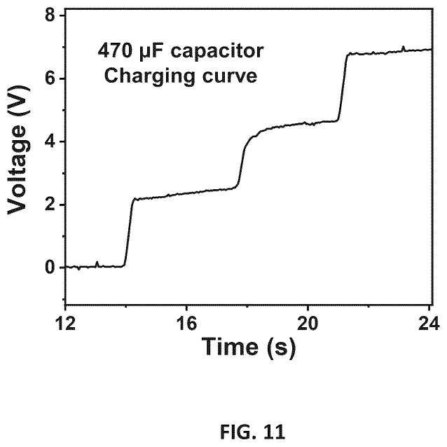

FIGS. 10A and 10B show output voltage and output current of the hybrid energy harvesting tile respectively. FIG. 11 shows a charging curve for charging a 470 μF capacitor using the hybrid energy harvesting tile.

While the present disclosure has been described and illustrated with reference to specific embodiments thereof, these descriptions and illustrations are not limited. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, subdivided, or re-ordered to form an equivalent method without departing from the teachings of the present disclosure. Accordingly, unless specifically indicated herein, the order and grouping of the operations are not limited.

What is claimed is:

1. A hybrid energy harvesting unit for harvesting kinetic energy from pedestrian stepping and generating electrical energy from the kinetic energy, comprising:
a triboelectric harvesting unit for harvesting kinetic energy from small-scale motions;
an electromagnetic harvesting unit for harvesting kinetic energy from large-scale motions; and
wherein the hybrid energy harvesting unit is operable at a compressed state when the hybrid energy harvesting unit is compressed by an external force and a released state when there is no external force compressing the hybrid energy harvesting unit.

2. The hybrid energy harvesting unit according to claim 1, comprising
a bottom plate;
a lower mounting frame arranged above the bottom plate;
an upper mounting frame arranged above the lower mounting frame;
a top plate arranged above the upper mounting frame;
a first spacing structure rigidly linking and spacing apart the lower mounting frame and the top plate;
a second spacing structure rigidly linking and spacing apart the upper mounting frame and the bottom plate; and
wherein the first spacing structure is arranged to pass through the upper mounting frame such that the top plate, the lower mounting frame and the first spacing structure forms a rigid body movable between a high position when the hybrid energy harvesting unit is at the released state and a low position when the hybrid energy harvesting unit is at the compressed state.

3. The hybrid energy harvesting unit according to claim 2, wherein
the triboelectric harvesting unit includes a first electrode disposed on a top surface of the upper mounting frame; a second electrode disposed on a bottom surface of the top plate; a first triboelectric layer made of a tribo-negative material and attached to the first electrode and a second triboelectric layer made of a tribo-positive material and attached to the second electrode; and
the first triboelectric layer is configured to be movable to be apart from or in contact with the second triboelectric layer.

4. The hybrid energy harvesting unit according to claim 2, wherein
the electromagnetic harvesting unit includes a first magnet fixed on a top surface of the bottom plate; a second magnet fixed to the upper mounting frame and aligned oppositely to the first magnet; a high-density conductive coil fixed on the lower mounting frame; and a magnetic core fixed on the lower mounting frame and surrounded by the conductive coil; and
the conductive coil and the magnetic core are configured to be movable up and down between the first and second magnets.

5. The hybrid energy harvesting unit according to claim 2, further comprising a first set of springs resiliently connecting the lower mounting frame and the bottom plate.

6. The hybrid energy harvesting unit according to claim 1, further comprising a power management circuitry installed on the lower board and including:
a first rectifier circuit electrically coupled to the triboelectric harvesting unit;
a first voltage boosting and stabilization circuit electrically coupled to the first rectifier circuit;
a second rectifier circuit electrically coupled to the electromagnetic harvesting unit;
a second voltage boosting and stabilization circuit electrically coupled to the second rectifier circuit;
a battery charging and discharging management circuit connected in parallel to the first and second voltage boosting and stabilization circuits; and
a load or battery electrically connect to the battery charging and discharging management circuit.

7. A hybrid energy harvesting tile for harvesting kinetic energy from pedestrian stepping and generating electrical energy from the kinetic energy, comprising:
a top board;
a bottom board;
a second set of springs arranged between and resiliently connecting the top board and the bottom board; and
an array of hybrid energy harvesting units of claim 1 arranged between and resiliently connecting the top board and the bottom board.

8. The hybrid energy harvesting tile according to claim 7, wherein
each hybrid energy harvesting unit further comprises:
a bottom plate;
a lower mounting frame arranged above the bottom plate;
an upper mounting frame arranged above the lower mounting frame;
a top plate arranged above the upper mounting frame;
a first spacing structure rigidly linking and spacing apart the lower mounting frame and the top plate; and
a second spacing structure rigidly linking and spacing apart the upper mounting frame and the bottom plate; and
wherein the first spacing structure is arranged to pass through the upper mounting frame such that the top plate, the lower mounting frame and the first spacing structure forms a rigid body movable between a high position when the hybrid energy harvesting unit is at the released state and a low position when the hybrid energy harvesting unit is at the compressed state.

9. The hybrid energy harvesting tile according to claim 8, wherein
the triboelectric harvesting unit includes a first electrode disposed on a top surface of the upper mounting frame; a second electrode disposed on a bottom surface of the top plate; a first triboelectric layer made of a tribo-negative material and attached to the first electrode and a second triboelectric layer made of a tribo-positive material and attached to the second electrode; and
the first triboelectric layer is configured to be movable to be apart from or in contact with the second triboelectric layer.

10. The hybrid energy harvesting tile according to claim 8, wherein
the electromagnetic harvesting unit includes a first magnet fixed on a top surface of the bottom plate; a second magnet fixed to the upper mounting frame and aligned oppositely to the first magnet; a high-density conductive coil fixed on the lower mounting frame; and a magnetic core fixed on the lower mounting frame and surrounded by the conductive coil; and
the conductive coil and the magnetic core are configured to be movable up and down between the first and second magnets.

11. The hybrid energy harvesting tile according to claim 8, wherein each hybrid energy harvesting unit further includes a first set of springs resiliently connecting the lower mounting frame and the bottom plate.

12. The hybrid energy harvesting tile according to claim 7, wherein
each hybrid energy harvesting further comprises a power management circuitry installed on the lower board; and
the power management circuitry includes:
a first rectifier circuit electrically coupled to the triboelectric harvesting unit;
a first voltage boosting and stabilization circuit electrically coupled to the first rectifier circuit;
a second rectifier circuit electrically coupled to the electromagnetic harvesting unit;
a second voltage boosting and stabilization circuit electrically coupled to the second rectifier circuit;
a battery charging and discharging management circuit connected in parallel to the first and second voltage boosting and stabilization circuits; and
a load or battery electrically connect to the battery charging and discharging management circuit.

13. A hybrid energy harvesting floor system for harvesting kinetic energy from pedestrian stepping and generating electrical energy from the kinetic energy, comprising one or more hybrid energy harvesting tiles of claim 7.

14. The hybrid energy harvesting floor system according to claim 13, wherein
each hybrid energy harvesting unit further comprises:
a bottom plate;
a lower mounting frame arranged above the bottom plate;
an upper mounting frame arranged above the lower mounting frame;
a top plate arranged above the upper mounting frame;
a first spacing structure rigidly linking and spacing apart the lower mounting frame and the top plate; and
a second spacing structure rigidly linking and spacing apart the upper mounting frame and the bottom plate; and
wherein the first spacing structure is arranged to pass through the upper mounting frame such that the top plate, the lower mounting frame and the first spacing structure forms a rigid body movable between a high position when the hybrid energy harvesting unit is at the released state and a low position when the hybrid energy harvesting unit is at the compressed state.

15. The hybrid energy harvesting floor system according to claim 14, wherein
the triboelectric harvesting unit includes a first electrode disposed on a top surface of the upper mounting frame; a second electrode disposed on a bottom surface of the top plate; a first triboelectric layer made of a tribo-negative material and attached to the first electrode and a second triboelectric layer made of a tribo-positive material and attached to the second electrode; and
the first triboelectric layer is configured to be movable to be apart from or in contact with the second triboelectric layer.

16. The hybrid energy harvesting floor system according to claim 14, wherein
the electromagnetic harvesting unit includes a first magnet fixed on a top surface of the bottom plate; a second magnet fixed to the upper mounting frame and aligned oppositely to the first magnet; a high-density conductive coil fixed on the lower mounting frame; and a magnetic core fixed on the lower mounting frame and surrounded by the conductive coil; and
the conductive coil and the magnetic core are configured to be movable up and down between the first and second magnets.

17. The hybrid energy harvesting floor system according to claim 14, wherein the hybrid energy harvesting unit further includes a first set of springs resiliently connecting the lower mounting frame and the bottom plate.

18. The hybrid energy harvesting floor system according to claim 13, wherein
each hybrid energy harvesting further comprises a power management circuitry installed on the lower board; and
the power management circuitry includes:
a first rectifier circuit electrically coupled to the triboelectric harvesting unit;
a first voltage boosting and stabilization circuit electrically coupled to the first rectifier circuit;
a second rectifier circuit electrically coupled to the electromagnetic harvesting unit;
a second voltage boosting and stabilization circuit electrically coupled to the second rectifier circuit;
a battery charging and discharging management circuit connected in parallel to the first and second voltage boosting and stabilization circuits; and
a load or battery electrically connect to the battery charging and discharging management circuit.
